(19) United States
(12) Patent Application Publication
(10) Pub. No.: US 2009/0246431 A1
(43) Pub. Date: Oct. 1, 2009

(54) Polypropylene containers having a barrier layer for the packaging, storage and preservation of foods

(75) Inventors: Walter Lendle, Eschborn (DE); Burkhard Wehefritz, Mainz (DE)

Correspondence Address: LyondellBasell Industries, 3801 WEST CHESTER PIKE, NEWTOWN SQUARE, PA, 19073, US

(73) Assignee: Basell Polyolefine GmbH, Wesseling (DE)

(21) Appl. No.: 12/309,151

(22) PCT Filed: Jul. 7, 2007
(86) PCT No.: PCT/EP2007/006038

§ 371 Date: Jan. 8, 2009

Related U.S. Application Data
(60) Provisional application No. 60/841,290, filed on Aug. 30, 2006.

(30) Foreign Application Priority Data
Jul. 14, 2006 (DE) 10 2006 033 102.8

(51) Int. Cl. B32B 27/08

(52) U.S. Cl. 428/36.6

(57) ABSTRACT

The present invention relates to the use of polypropylene containers for the packaging, storage and preservation of foods, with the containers having wall thicknesses of at least 0.4 mm and the polypropylene preferably being a transparent propylene homopolymer or propylene copolymer which has a haze value of ≦40%, based on a layer thickness of the polypropylene of 1 mm and measured on injection-molded test specimens, and has a tensile modulus of elasticity of ≧700 MPa, in the case of a homopolymer preferably ≧1500 MPa, and a Charpy notched impact toughness at 0° C. of ≧3 kJ/m² and at a layer thickness of 100 μm has an oxygen permeability of ≦1000 cm/³/m².d.bar, and, likewise at a layer thickness of 100 μm, has a permeability to water vapor of ≦1 g/m².

In addition, the invention relates to transparent polypropylene containers which can be closed so as to be airtight and watertight and are suitable for the preservation of foods.

The present invention relates to the use of polypropylene containers for the packaging, storage or preservation of foods, for example sausages, and to specific transparent polypropylene containers which are suitable for the packaging, storage or preservation of foods.

Metal cans, glass bottles or plastic packages are used for the packaging and preservation of foods, but these all have certain disadvantages. Metal cans make good preservation with long storage times possible, but are opaque so that the product is not visible from the outside. Glass bottles have a considerable weight and are easily broken while conventional plastic packages allow only a short storage time. A further disadvantage of, in particular, metal cans is their low reuse value. They are essentially single-use packaging which has to be disposed of by the purchaser.

A class of plastics which is frequently well-suited for packaging applications comprises polypropylenes. These generally have advantageous mechanical properties such as satisfactory hardness, stiffness and shape stability. In addition, they have good economics. However, the toughness, in particular at low temperatures, the stress whitening behavior, the distortion, the permeability for gases and liquids and especially the transparency frequently leaves something to be desired.

It was therefore an object of the present invention to overcome the abovementioned disadvantages of the prior art and to discover containers which are suitable for the packaging and storage of food articles and, in particular, allow the foods to be kept for a long time, have good mechanical properties, provide easy handling of the packages and can be produced economically with low distortion.

We accordingly propose the use of transparent polypropylene containers for the packaging, storage and preservation of foods, with the containers comprising polypropylene and additionally comprising a suitable barrier layer which reduces the permeation of oxygen. The containers have wall thicknesses of at least 0.4 mm. The transparent polypropylene is preferably a propylene homopolymer or propylene copolymer which has a haze value of ≦40%, based on a layer thickness of the polypropylene of 1 mm and measured on injection-molded test specimens, and has a tensile modulus of elasticity of ≧700 MPa, in the case of a homopolymer preferably ≧1500 MPa, and a Charpy notched impact toughness at 0° C. of ≧3 kJ/m²The containers preferably have an oxygen permeability at a layer thickness of 100 μm of ≦1000 cm³/m².d.bar, preferably ≦10 cm³/m².d.bar, and, likewise at a layer thickness of 100 μm, a permeability to water vapor of ≦1 g/m².d.bar. Water permeability was determined according to DIN 53 122 part 2. Determination of oxygen permeability was performed according to DIN 53 380 part 3 at a humidity of 53%.

Furthermore, transparent polypropylene containers which are suitable for the packaging, storage and in particular preservation of foods are provided.

According to the invention, a transparent polypropylene is used for producing the containers. Here, the term polypropylene refers to a polymer which has been prepared using at least 50% by weight of propylene as monomer. Conceivable comonomers are, in particular, α-olefins, i.e. hydrocarbons having terminal double bonds. Preferred α-olefins are linear or branched C₂-C₂₀-1-alkenes other than propylene, in particular linear C₂-C₁₀-1-alkenes or branched C₄-C₁₀-1-alkenes such as 4-methyl-1-pentene, conjugated and nonconjugated dienes such as 1,3-butadiene, 1,4-hexadiene or 1,7-octadiene or vinylaromatic compounds such as styrene or substituted styrene. Suitable olefins also include ones in which the double bond is part of a cyclic structure which can have one or more ring systems. Examples are cyclopentene, norbornene, tetracyclododecene and methylnorbornene and dienes such as 5-ethylidene-2-norbornene, norbornadiene or ethylnorbornadiene. It is also possible to copolymerize a mixture of two or more olefins with propylene. Particularly preferred olefins are ethylene and linear C₄-C₁₀-1-alkenes such as 1-butene, 1-pentene, 1-hexene, 1-heptene, 1-octene, 1-decene and in particular ethylene and/or 1-butene.

The transparent polypropylene used according to the invention for producing the containers has a haze value, based on a layer thickness of the polypropylene of 1 mm and measured on injection-molded test specimens in accordance with the standard ASTM D 1003, of ≦40%, preferably ≦25%. particularly preferably ≦15% and very particularly preferably ≦12%. The haze value is a measure of the cloudiness of the material and is thus a parameter which characterizes the transparency of the material. The lower the haze value, the higher the transparency.

Furthermore, the material has a low solubility in xylene and a low H₂O and O₂ permeability. The O₂ permeability can be reduced further by means of suitable additional barriers. The polypropylene used according to the invention has a solubility in xylene at 70° C. of ≦3%, preferably ≦1%, based on the polymer. The O₂ permeability at a layer thickness of 100 μm is ≦1000 cm³/m².d.bar, preferably ≦800 cm³/dm².d.bar, with additional barrier layers even ≦10 cm³/m².d.bar, and the permeability to water vapor is ≦1 g/m².d.bar, preferably ≦50 g/m².d.bar, likewise at a layer thickness of 100 μm.

Furthermore, the transparent polypropylene has an advantageous combination of stiffness and toughness. The tensile modulus of elasticity of the transparent polypropylene is ≧700 MPa and preferably ≧800 MPa, in the case of a homopolymer preferably ≧1500 MPa and particularly preferably ≧1800 MPa, measured in accordance with ISO 527-2:1993. To determine the tensile modulus of elasticity, preference is given to injection molding a test specimen of type 1 having a total length of 1500 mm and a parallel section of 80 mm at a melt temperature of 250° C. and a tool surface temperature of 30° C. The test specimen is then stored under standard conditions of 23° C./50% atmospheric humidity for 7 days to allow after-crystallization. The test speed in the determination of the modulus of elasticity should be 1 mm/min. The toughness of the transparent polypropylene, determined as Charpy notched impact toughness at 0° C., is ≧3 kJ/m²preferably ≧4 kJ/m² and particularly preferably ≧26 kJ/m²The Charpy notched impact toughness is measured in accordance with the standard EN ISO 179-1.

Furthermore, the transparent polypropylene has good stress whitening behavior. The term stress whitening refers to the occurrence of whitish discolored areas in the stressed region on mechanical stressing of the polymer. It is generally believed that the whitening is caused by small voids being formed in the polymer under mechanical stress. Good stress whitening behavior means that no or only very small regions having a whitish color occur on mechanical stressing.

One method of quantifying the stress whitening behavior is to subject defined test specimens to a defined impact stress and then measure the size of the white spots formed. Accordingly, in the dome indenter method, a falling weight is allowed to drop onto a test specimen by means of a falling weight apparatus in accordance with DIN 53443 part 1. Here, a falling weight having a mass of 250 g and an impact head having a diameter of 5 mm is used. The dome radius is 25 mm and the height from which the weight is dropped is 50 cm. Test specimens used are injection-molded round disks having a diameter of 60 mm and a thickness of 2 mm, with each test specimen being subjected to only one impact test. The stress whitening is reported as the diameter of the visible stress whitening mark in mm and is the mean of 5 test specimens in each case, with the individual values being determined on the side of the round disk facing away from the impact as the mean of the two values in the flow direction during injection molding and perpendicular thereto.

The transparent polypropylene has no or only very little stress whitening, determined by the dome indenter method, at 23° C. In the case of preferred transparent polypropylenes, a value of from 0 to 8 mm, preferably from 0 to 5 mm and in particular from 0 to 2.5 mm, is determined by the dome indenter method at 23° C. Very particularly preferred transparent polypropylenes display no stress whitening at all in the dome indenter test at 23° C.

Suitable transparent polypropylenes are homopolymers of propylene or preferably copolymers of propylene which have been obtained using catalyst systems based on metallocene compounds.

Suitable transparent polypropylenes can also be heterophase propylene copolymers, which are also referred to as multiphase propylene copolymers or as propylene block copolymers. Such compositions are usually present in the form of separate phases, generally with a polyolefin having a relatively low stiffness being dispersed in the matrix of a propylene polymer having a higher stiffness.

Heterophase propylene copolymers which are suitable as transparent polypropylenes are, for example, those which have a copolymer of ethylene and 1-butene as soft phase.

Heterophase propylene copolymers comprising a propylene polymer A which forms the matrix and a propylene copolymer B dispersed therein and prepared using catalyst systems based on metallocene compounds are particularly suitable.

The propylene polymer A can be a propylene homopolymer or a propylene copolymer comprising up to 15% by weight and preferably 10% by weight of olefins other than propylene, with preferred propylene copolymers comprising from 1.5 to 7% by weight, in particular from 2.5 to 5% by weight, of olefins other than propylene. As comonomers, preference is given to using ethylene or linear C₄-C₁₀-1-alkenes or mixtures thereof, in particular ethylene and/or 1-butene.

The propylene copolymers B usually comprise from 5 to 40% by weight of olefins other than propylene. It is also possible for two or more different propylene copolymers, which can differ both in respect of the copolymerized content and in the type of the olefin or olefins other than propylene, to be comprised as component B. Preferred comonomers are ethylene or linear C₄-C₁₀-1-alkenes or mixtures thereof, in particular ethylene and/or 1-butene. In a further preferred embodiment, monomers comprising at least two double bonds, e.g. 1,7-octadiene or 1,9-decadiene, are additionally used. The content of olefins other than propylene in the propylene copolymers is generally from 7 to 25% by weight, preferably from 10 to 20% by weight, particularly preferably from 12 to 18% by weight and in particular from 14 to 17% by weight, based on the propylene copolymer B.

The weight ratio of propylene polymer A to propylene copolymer B can vary. It is preferably from 90:10 to 60:40, particularly preferably from 80:20 to 60:40 and very particularly preferably from 70:30 to 60:40, with all propylene copolymers forming the component B being included under propylene copolymer B.

Such a preferred transparent polypropylene preferably has a narrow molar mass distribution M_{w}/MₙThe molar mass distribution M_{w}/Mₙ is, for the purposes of the invention, the ratio of the weight average molar mass M_{w} to the number average molar mass Mₙ. The molar mass distribution M_{w}/Mₙ is preferably in the range from 1.5 to 3.5, particularly preferably in the range from 1.8 to 2.5 and in particular in the range from 2 to 2.3.

The mean molar mass Mₙ of the preferred transparent polypropylene is preferably in the range from 20 000 g/mol to 500 000 g/mol, particularly preferably in the range from 50 000 g/mol to 200 000 g/mol and very particularly preferably in the range from 80 000 g/mol to 150 000 g/mol.

The preferred transparent polypropylenes are preferably prepared using catalyst systems based on metallocene compounds of transition metals of groups 3, 4, 5 or 6 of the Periodic Table of the Elements.

Particular preference is given to catalyst systems based on metallocene compounds of the general formula (I)

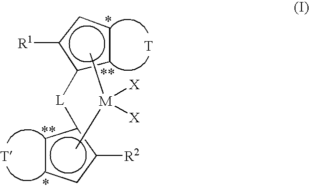

where
M is zirconium, hafnium or titanium, preferably zirconium,
the radicals X are identical or different and are each, independently of one another, hydrogen or halogen or an —R, —OR, —OSO₂CF₃, —OCOR, —SR, —NR₂ or —PR₂ group, where R is linear or branched C₁-C₂₀-alkyl, C₃-C₂₀-cycloalkyl which may optionally bear one or more C₁-C₁₀-alkyl radicals as substituents, C₆-C₂₀-aryl, C₇-C₂₀-alkylaryl or C₇-C₂₀-arylalkyl and may optionally comprise one or more heteroatoms of groups 13-17 of the Periodic Table of the Elements or one or more unsaturated bonds and is preferably C₁-C₁₀-alkyl such as methyl, ethyl, n-propyl, isopropyl, n-butyl, isobutyl, sec-butyl, tert-butyl, n-pentyl, n-hexyl, n-heptyl or n-octyl or C₃-C₂₀-cycloalkyl such as cyclopentyl or cyclohexyl, where the two radicals X can also be joined to one another and preferably form a C₄-C₄₀-dienyl ligand, in particular a 1,3-dienyl ligand or an —OR′O— group in which the substituent R′ is a divalent group selected from the group consisting of C₁-C₄₀-alkylidene, C₆-C₄₀-arylidene, C₇-C₄₀-alkylarylidene and C₇-C₄₀-arylalkylidene,
where X is preferably a halogen atom or an —R or —OR group or the two radicals X form a —OR′—O— group and X is particularly preferably chlorine or methyl,
L is a divalent bridging group selected from the group consisting of C₁-C₂₀-alkylidene, C₃-C₂₀-cycloalkylidene, C₆-C₂₀-arylidene, C₇-C₂₀-alkylarylidene and C₇-C₂₀-arylalkylidene radicals which may optionally comprise heteroatoms of groups 13-17 of the Periodic Table of the Elements or a silylidene group having up to 5 silicon atoms, e.g. —SiMe₂— or —SiPh₂—,
where L is preferably a radical selected from the group consisting of —SiMe₂—, —SiPh₂—, —SiPhMe—, —SiMe(SiMe₃)—, —CH₂—, —CH₂)₂—, —(CH₂)₃— and —C(CH₃)₂—,
R¹ is linear or branched C₁-C₂₀-alkyl, C₃-C₂₀-cycloalkyl which may optionally bear one or more C₁-C₁₀-alkyl radicals as substituents, C₆-C₂₀-aryl, C₇-C₂₀-alkylaryl or C₇-C₂₀-arylalkyl and may optionally comprise one or more heteroatoms from groups 13-17 of the Periodic Table of the Elements or one or more unsaturated bonds, with R¹ preferably being unbranched in the α position,
where R¹ is preferably a linear or branched C₁-C₁₀-alkyl group which is unbranched in the α position and in particular a linear C₁-C₄-alkyl group such as methyl, ethyl, n-propyl or n-butyl,
R² is a group of the formula —C(R³)₂R⁴, where
the radicals R³ are identical or different and are each, independently of one another, linear or branched C₁-C₂₀-alkyl, C₃-C₂₀-cycloalkyl which may optionally bear one or more C₁-C₁₀-alkyl radicals as substituents, C₆-C₂₀-aryl, C₇-C₂₀-alkylaryl or C₇-C₂₀-arylalkyl and may optionally comprise one or more heteroatoms of groups 13-17 of the Periodic Table of the Elements or one or more unsaturated bonds, or two radicals R³ may be joined to form a saturated or unsaturated C₃-C₂₀ ring,
where R³ is preferably a linear or branched C₁-C₁₀-alkyl group, and
R⁴ is hydrogen or linear or branched C₁-C₂₀-alkyl, C₃-C₂₀-cycloalkyl which may optionally bear one or more C₁-C₁₀-alkyl radicals as substituents, C₆-C₂₀-aryl, C₇-C₂₀-alkylaryl or C₇-C₂₀-arylalkyl and may optionally comprise one or more heteroatoms of groups 13-17 of the Periodic Table of the Elements or one or more unsaturated bonds,
where R⁴ is preferably hydrogen,
T and T′ are divalent groups of the general formula (II), (III), (IV), (V) or (VI),

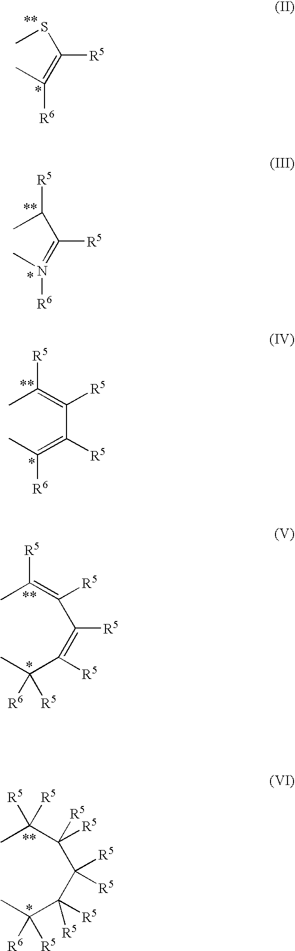

where
the atoms denoted by the symbols * and ** are in each case connected to the atoms of the compound of the formula (I) which are designated by the same symbol, and
the radicals R⁵ are identical or different and are each, independently of one another, hydrogen or halogen or linear or branched C₁-C₂₀-alkyl, C₃-C₂₀-cycloalkyl which may optionally bear one or more C₁-C₁₀-alkyl radicals as substituents, C₆-C₂₀-aryl, C₇-C₂₀-alkylaryl or C₇-C₂₀-arylalkyl and may optionally comprise one or more heteroatoms of groups 13-17 of the Periodic Table of the Elements or one or more unsaturated bonds,
where R⁵ is preferably hydrogen or a linear or branched C₁-C₁₀-alkyl group and in particular a linear C₁-C₄-alkyl group such as methyl, ethyl, n-propyl or n-butyl, and
the radicals R⁶ are identical or different and are each, independently of one another, halogen or linear or branched C₁-C₂₀-alkyl, C₃-C₂₀-cycloalkyl which may optionally bear one or more C₁-C₁₀-alkyl radicals as substituents, C₆-C₂₀-aryl, C₇-C₂₀-alkylaryl or C₇-C₂₀-arylalkyl and may optionally comprise one or more heteroatoms of groups 13-17 of the Periodic Table of the Elements or one or more unsaturated bonds,
where R⁶ is preferably an aryl group of the general formula (VII),

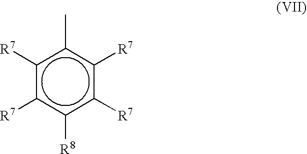

where
the radicals R⁷ are identical or different and are each, independently of one another, hydrogen or halogen or linear or branched C₁-C₂₀-alkyl, C₃-C₂₀-cycloalkyl which may optionally bear one or more C₁-C₁₀-alkyl radicals as substituents, C₆-C₂₀-aryl, C₇-C₂₀-alkylaryl or C₇-C₂₀-arylalkyl and may optionally comprise one or more heteroatoms of groups 13-17 of the Periodic Table of the Elements or one or more unsaturated bonds or two radicals R⁷ may be joined to form a saturated or unsaturated C₃-C₂₀ ring,
where R⁷ is preferably a hydrogen atom, and
R⁸ is hydrogen or halogen or linear or branched C₁-C₂₀-alkyl, C₃-C₂₀-cycloalkyl which may optionally bear one or more C₁-C₁₀-alkyl radicals as substituents, C₆-C₂₀-aryl, C₇-C₂₀-alkylaryl or C₇-C₂₀-arylalkyl and may optionally comprise one or more heteroatoms of groups 13-17 of the Periodic Table of the Elements or one or more unsaturated bonds, where R⁸ is preferably a branched alkyl group of the formula —C(R⁹)₃, where
the radicals R⁹ are identical or different and are each, independently of one another, a linear or branched C₁-C₆-alkyl group or two or three radicals R⁹ are joined to form one or more ring systems.

Preference is given to at least one of the groups T and T′ being substituted by a radical R⁶ of the general formula (VII) and particular preference is given to both groups being substituted by such a radical. Very particular preference is given to at least one of the groups T and T′ being a group of the formula (IV) which is substituted by a radical R⁶ of the general formula (VII) and the other being described by either the formula (II) or (IV) and likewise being substituted by a radical R⁶ of the general formula (VII).

Very particular preference is given to catalyst systems based on metallocene compounds of the general formula (VIII),

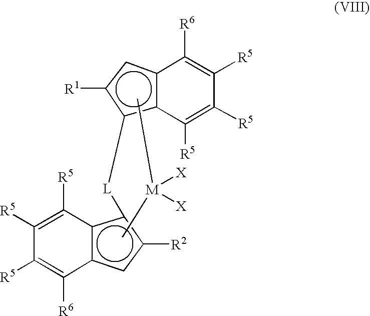

Particularly useful metallocene compounds and processes for preparing them are described, for example, in WO 01/48034 and the international application No. PCT/EP02/13552.

It is also possible to use mixtures of various metallocene compounds or mixtures of various catalyst systems. However, preference is given to using only one catalyst system comprising one metallocene compound, with this being used for the polymerization of the propylene polymer A and the propylene copolymer B.

Examples of suitable metallocene compounds are
dimethylsilanediyl(2-ethyl-4-(4′-tert-butylphenyl)indenyl)(2-isopropyl4-(4′-tert-butylphenyl)indenyl)zirconium dichloride,
dimethylsilanediyl(2-methyl-4-(4′-tert-butylphenyl)indenyl)2-isopropyl4-(1-naphthyl)indenyl)zirconium dichloride,
dimethylsilanediyl(2-methyl-4-phenyl-1-indenyl)(2-isopropyl-4-(4′-tert-butylphenyl)-1-indenyl)zirconium dichloride,
dimethylsilanediyl(2-methylthiapentenyl)(2-isopropyl-4-(4′-tert-butylphenyl)indenyl)zirconium dichloride,
dimethylsilanediyl(2-isopropyl-4-(4′-tert-butylphenyl)indenyl)(2-methyl-4,5-benzoindenyl)zirconium dichloride,
dimethylsilanediyl(2-methyl-4-(4′-tert-butylphenyl)indenyl)(2-isopropyl-4-(4′-tert-butylphenyl)indenyl)zirconium dichloride,
dimethylsilanediyl(2-methyl4-(4′-tert-butylphenyl)indenyl)(2-isopropyl4-phenylindenyl)zirconium dichloride,
dimethylsilanediyl(2-ethyl4-(4′-tert-butylphenyl)indenyl)(2-isopropyl-4-phenyl)indenyl)zirconium dichloride or
dimethylsilanediyl(2-isopropyl-4-(4′-tert-butylphenyl)indenyl)(2-methyl-4-(1-naphthyl)indenyl)zirconium dichloride
   or mixtures thereof.

Furthermore, the preferred catalyst systems based on metallocene compounds generally comprise compounds which form metallocenium ions as cocatalysts. Suitable compounds of this type are strong, uncharged Lewis acids, ionic compounds having Lewis-acid cations or ionic compounds having Brönsted acids as cation. Examples are tris(pentafluorophenyl)borane, tetrakis(pentafluorophenyl)borate and salts of N,N-dimethylanilinium. Likewise suitable as compounds which form metallocene ions and thus as cocatalysts are open-chain or cyclic aluminoxane compounds. These are usually prepared by reaction of trialkylaluminum with water and are generally in the form of mixtures of both linear and cyclic chain molecules of various lengths or cage molecules of various sizes. The preferred catalyst systems based on metallocene compounds are usually used in supported form. Suitable supports are, for example, porous, inert organic or inorganic solids such as finely divided polymer powders or inorganic oxides, for example silica gel. In addition, the metallocene catalyst systems can comprise organometallic compounds of metals of groups 1, 2 or 13 of the Periodic Table, e.g. n-butyllithium or aluminum alkyl.

In the preparation of the particularly preferred heterophase compositions, the propylene polymer A is preferably firstly formed in a first stage by polymerizing, based on the total weight of the mixture, from 90% by weight to 100% by weight of propylene, if appropriate in the presence of further olefins, usually at temperatures in the range from 40° C. to 120° C. and pressures in the range from 0.5 bar to 200 bar. In a second stage, a mixture of from 2 to 95% by weight of propylene and from 5% to 98% by weight of further olefins is subsequently polymerized, usually at temperatures in the range from 40° C. to 120° C. and pressures in the range from 0.5 bar to 200 bar, onto the polymer obtainable by means of this reaction. The polymerization of the propylene polymer A is preferably carried out at a temperature of from 60 to 80° C., particularly preferably from 65 to 75° C., and a pressure of from 5 to 100 bar, particularly preferably from 10 bar to 50 bar. The polymerization of the propylene copolymer B is preferably carried out at a temperature of from 60 to 80° C., particularly preferably from 65 to 75° C., and a pressure of from 5 to 100 bar, particularly preferably from 10 bar to 50 bar.

It is possible to use customary additives, for example molar mass regulators such as hydrogen or inert gases such as nitrogen or argon, in the polymerization.

The composition of the propylene copolymers B of the preferred polypropylenes which are prepared using catalyst systems based on metallocene compounds is preferably uniform. They have little comonomer incorporated in a block-like fashion. The term “incorporated in a block-like fashion” is used to mean that two or more comonomer units follow one another directly.

In the preferred propylene copolymers B of propylene and ethylene, the structure can be determined by ¹³C NMR spectroscopy. The evaluation is prior art and can be carried out by a person skilled in the art, e.g. as described in H. N. Cheng, Macromolecules 17 (1984), pp. 1950-1955 or L. Abis et al., Makromol. Chemie 187 (1986), pp. 1877-1886. The structure can be described by the proportions of “PEₓ” and of “PEP”where PEₓ are the propylene-ethylene units having ≧2 adjacent ethylene units and PEP are the propylene-ethylene units having an isolated ethylene unit between two propylene units. Preferred propylene copolymer compositions obtained from propylene and ethylene have a PEP/PEₓ ratio in the range from 0.75 to ≧1, preferably in the range from 0.85 to ≧1.4 and particularly preferably in the range from 0.85 to 1.2 and in particular in the range from 0.9 to 1.1.

In the case of the preferred use of ethylene as comonomer, it is particularly preferred for an ethylene content of the propylene copolymers B of from 10 to 20% by weight, in particular from 12 to 18% by weight and particularly preferably about 16% by weight, to be set. The transparency of the propylene copolymer compositions used according to the invention is virtually independent of the proportion of the propylene copolymer B comprised.

Particularly useful heterophase propylene copolymers which are suitable as transparent polypropylenes are ones which comprise
A) from 50 to 98% by weight, preferably from 60 to 95% by weight, of a crystalline propylene homopolymer or a crystalline random copolymer of propylene with ethylene and/or C₄-C₁₀-1-alkenes having a content of from 0.5 to 15% by weight of ethylene and/or C₄-C₁₀-1-alkenes and
B) from 2 to 50% by weight, preferably from 5 to 40% by weight, of (i) an elastomeric copolymer of ethylene with one or more C₄-C₁₀-1-alkenes (copolymer (a)) which comprises from 60 to 85% by weight of ethylene or (ii) a blend of copolymer (a) with a copolymer of propylene with from >15% to 40% of ethylene (copolymer (b)), with the weight ratio of (a)/(b) preferably being from 1/4 to 4/1.

Examples of C₄-C₁₀-1-alkenes which can be used as comonomers in the fractions A and B are 1-butene, 1-pentene, 1-hexene and 4-methyl-1-pentene. Particular preference is given to 1-butene.

The MFR (230° C./2.16 kg) determined in accordance with ISO 1133 of these heterophase propylene copolymers is preferably from 0.1 to 100 g/10 min.

Such suitable heterophase propylene copolymers are normally prepared by sequential copolymerization of the monomers in the presence of stereospecific Ziegler-Natta catalysts supported on magnesium dihalide. The polymerization is carried out in at least two steps; the synthesis of the polymer of the fraction A is effected in the first step and the synthesis of the polymer of the fraction B is effected in the second step. The synthesis of the latter is carried out in the presence of the polymer obtained in the preceding step and on the catalyst used in the preceding step. Reaction times and temperatures in the two stages are not critical and are preferably in the range from 0.5 to 5 hours and from 50° C. to 90° C. The molecular weight is set by means of customary molecular weight regulators, e.g. hydrogen and ZnEt₂.

Suitable stereospecific catalysts comprise the reaction product of:
i) a solid component comprising a titanium compound and an electron donor compound (internal electron donor) supported on magnesium chloride,
ii) an aluminum alkyl compound (cocatalyst) and, if desired,
iii) an electron donor compound (external electron donor).

These catalysts are preferably suitable for the preparation of propylene homopolymers having an isotacticity index of greater than 90%.

Catalysts having the properties indicated above are well known from the patent literature. The catalysts described in U.S. Pat. No. 4,399,054 and EP-A 45977 are particularly advantageous.

The solid catalyst component (i) comprises, as electron donor, a compound which is generally selected from among ethers, ketones, lactones, compounds comprising an N, P and/or S atom and monocarboxylic and dicarboxylic esters.

Phthalic esters and succinic esters are particularly useful. Other electron donors which are particularly useful are 1,3-diethers, as is described in the published European patent applications EP-A 361 493 and EP-A 728 769.

As cocatalysts (ii), preference is given to using trialkylaluminum compounds such as triethylaluminum, triisobutylaluminum and tri-n-butylaluminum.

The electron donor compounds (iii) which are used as external electron donors (and are added to the aluminum alkyl compound) encompass aromatic acid esters (e.g. alkyl benzoates), heterocyclic compounds (e.g. 2,2,6,6-tetramethylpiperidine and 2,6-diisopropylpiperidine) and in particular silicon compounds which comprise at least one Si—OR bond (where R is a hydrogen radical). The abovementioned 1,3-diethers are likewise suitable for use as external donors. If a 1,3-diether is used as internal donor, the external donor can be omitted.

Particularly useful transparent polypropylenes which are prepared using catalyst systems based on metallocene compounds or using stereospecific Ziegler-Natta catalysts supported on the magnesium dihalides are preferably prepared in a multistage polymerization process having at least two polymerization stages connected in series, generally in the form of a reactor cascade. It is possible to use conventional reactors as are customarily used for propylene polymerization. The polymerization can be carried out in a known manner in bulk, in suspension, in the gas phase or in a supercritical medium. It can be carried out In a batch reactor or preferably continuously. Solution processes, suspension processes, stirred gas-phase processes or gas-phase processes in a fluidized-bed reactor are all possible. As solvent or suspension medium, it is possible to use inert hydrocarbons, for example isobutane, or the monomers themselves. One or more stages of the process used according to the invention can be carried out in one or more reactors. The size of the reactor is not of critical importance in the process used according to the invention. It depends on the amount of product in the reaction zone or the individual reaction zones.

Preference is given to processes in which the polymerization of the second stage in which the propylene copolymer(s) B or fraction B is (are) formed occurs in the gas phase. The preceding polymerization to form propylene polymer A or the fraction A can be carried out either in bulk, i.e. in liquid propylene as suspension medium, or equally well from the gas phase. If all polymerizations take place in the gas phase, the process is preferably carried out in a cascade of stirred gas-phase reactors connected in series. The fluidized bed generally comprises the polymer which is formed by polymerization in the respective reactor. If the polymerization to form the propylene polymer A is carried out in bulk, the process is preferably carried out in a cascade comprising one or more loop reactors and one or more gas-phase fluidized-bed reactors.

The amount of monomer fed into the individual stages and the process conditions, e.g. pressure, temperature or the addition of molecular weight regulators such as hydrogen, are selected so that the polymers formed have the desired properties.

Customary additives, for example molecular weight regulators such as hydrogen or inert gases such as nitrogen or argon, can likewise be used in the polymerization.

The transparent polypropylenes generally comprise customary additives which are permitted for food and are known to those skilled in the art, e.g. stabilizers, lubricants and mold release agents, fillers, nucleating agents, antistatics, plasticizers, dyes, pigments or flame retardants, in customary amounts. In general, these are incorporated in the polymerization of the product obtained in pulverulent form in the polymerization.

The container is made up of at least two layers, viz. at least one polypropylene layer and a barrier layer. Suitable barrier materials are, for example, ethylene-vinyl alcohol copolymers (EVOH) and silicates. Where ethylene-vinyl alcohol copolymers can also be used in deep drawing, silicate barrier layers are suitable first and foremost for injection-molded parts.

The containers are used for the packaging, storage and preservation of foods. For example, they are suitable for the packaging, storage and preservation of foods of all types, e.g. sausages, fruit preserves and vegetable preserves.

The containers have wall thicknesses of at least 0.4 mm, preferably at least 0.8 mm. Greater wall thicknesses, e.g. 1.0 mm, are conceivable. The wall thickness of the containers can be approximately equal in all regions of the containers. However, they can preferably also have reinforcements or ribs. The containers generally have standard sizes as are customary in the food sector.

Preferred containers are made up of two parts and comprise a cylindrical hollow body for accommodating the food and a lid. The hollow body for accommodating the food and the lid are preferably connected to one another so as to be airtight and impermeable to water vapor. Connection by means of welding or else a screw connection are conceivable.

Furthermore, the hollow bodies for accommodating the food are preferably configured so that they can be stacked on top of one another in the filled state.

Screw lids are, in order to save material and space, preferably configured with an external thread which engages in an internal thread at the rim of the cylindrical hollow body. However, lids which engage over the rim of the cylindrical hollow body are also conceivable. Other frictional but also positive (locking) connections are also possible. Frictional connections for preserves can also be closed by means of reduced pressure. In this case, the lids should be secured by clips or other fastening means. Preservation itself is effected by methods known for tinned plate cans.

The containers are preferably produced by deep drawing. However, the containers can also be obtained by injection molding, blow molding and stretch blow molding and also shaping of extruded sheets.

1. A polypropylene container for the packaging, storage and preservation of foods, said container comprising a Polypropylene wall having a wall thicknesses of at least 0.4 mm, wherein the polypropylene wall is provided with a barrier layer for oxygen, and wherein the polypropylene is a transparent propylene homopolymer or propylene copolymer which has a haze value of ≦40%, based on a layer thickness of the polypropylene of 1 mm and measured on injection-molded test specimens, and has a tensile modulus of elasticity of ≧700 MPa and a Charpy notched impact toughness at 0° C. of ≧3 kJ/m² and at a layer thickness of 100 μm has an oxygen Permeability of ≦1000 cm/³/m².d.bar, preferably ≦1 cm³/m².d.bar, and, likewise at a layer thickness of 100 μm, has a permeability to water vapor of ≦1 g/m².

2. The container according to claim 1, wherein the barrier layer is an ethylene-vinyl alcohol copolymer or silicate.

3. (canceled)

4. (canceled)

5. The container according to claim 1, which comprises a cylindrical hollow body for accommodating the food and a lid being connected to the body so as to be gastight and impermeable to water.

6. The container according to claim 5, wherein the body and the lid are welded to one another.

7. The container according to claim 5, wherein the body and the lid are connected to one another by means of a screw connection, with the lid engaging in the hollow body.

8. The container according to claim 5, wherein the body is configured so that one can be stacked on the top of the other in the filled state.

9. The container according to claim 5, which is produced by deep drawing, injection molding, blow molding or stretch blow molding.

10. The container according to claim 1, wherein the polypropylene wall is coated with a barrier layer of ethylene-vinyl alcohol copolymer or silicate.

11. (canceled)

12. (canceled)
